(19) United States
(12) Patent Application Publication
(10) Pub. No.: US 2026/0007104 A1
(43) Pub. Date: Jan. 8, 2026

(54) DRAPER TRACK

(71) Applicant: MACDON INDUSTRIES LTD, Winnipeg (CA)

(72) Inventors: Eric Grenier, Somerset (CA); Evan Upgang, Elm Creek (CA); Jann Garbald, Winnipeg (CA)

(21) Appl. No.: 18/992,528

(22) PCT Filed: Aug. 8, 2022
(86) PCT No.: PCT/CA2022/051203

§ 371 Date: Jan. 8, 2025

(51) Int. Cl. A01D 57/20; A01D 41/06; A01D 61/00; A01D 61/02

(52) U.S. Cl. CPC A01D 57/20; A01D 41/06; A01D 61/006; A01D 61/02

(57) ABSTRACT

A draper track assembly is provided for use on a draper header for harvesting agricultural crops, where the draper header includes a header frame. The draper track assembly comprises a draper track, a support clamp and an intermediary support. The draper track has a track portion extending longitudinally from an inboard end to an outboard end and a mounting channel extending from a bottom of the track portion. The support clamp is configured to be fixedly coupled to the mounting channel. The support clamp also is configured to be fixedly coupled to a header frame. The intermediary support has a bracket. The bracket and the mounting channel are configured to interlock with each other to prevent lateral movement between the draper track and the intermediary support while allowing longitudinal expansion of the draper track. The intermediary support is configured to be fixedly coupled to the header frame.

### BACKGROUND OF THE INVENTION

### 1. Field of the Invention

The present invention relates to a draper assembly for a crop harvesting header, and more particularly, to a device for reducing wear experienced by draper cleats during operation of a draper assembly.

### 2. Description of Related Art

Draper headers for harvesting agricultural crops are known in the art. Typical draper headers include a header frame, a cutter bar operatively extending across a front portion of the header frame to cut the crops to be harvested, and a draper assembly to carry cut crop toward a discharge opening at the center of the draper header. The draper assembly includes side draper belts behind the cutter bar to carry the cut crop toward the center region of the header. The draper assembly may also include a feed draper belt that receives the cut crop material from the side drapers and carries it rearward through the discharge opening into a feeder house.

Each of the belts is typically a continuous loop of flexible material and includes cleats extending laterally along the outer surface of the belts in a direction perpendicular to the direction of belt travel. The cleats help to move the cut crop on the top run of the belts. However, because the side draper belts are made from a flexible material, they inherently sag so that the cleats tend to rub against the header frame under the return run of these belts, causing the draper to wear at the cleats over time.

To reduce the wear on the draper, plastic draper tracks can be mounted between the header frame and the draper assembly. Conventional draper tracks extend along the length of the draper assembly and are mounted at multiple points along the length of the track. During use, thermal expansion of the draper track causes the draper track material to deform and move away from the mounting surface between the mounting fasteners, which causes pressure points on the draper and leads to severe draper slat wear.

### SUMMARY OF THE INVENTION

According to one aspect of the invention, a draper track assembly is provided for use on a draper header for harvesting agricultural crops, where the draper header includes a header frame. The draper track assembly comprises a draper track, a support clamp and an intermediary support. The draper track has a track portion extending longitudinally from an inboard end to an outboard end and a mounting channel extending from a bottom of the track portion. The support clamp is configured to be fixedly coupled to the mounting channel. The support clamp also is configured to be fixedly coupled to a header frame. The intermediary support has a bracket. The bracket and the mounting channel are configured to interlock with each other to prevent lateral movement between the draper track and the intermediary support while allowing longitudinal expansion of the draper track. The intermediary support is configured to be fixedly coupled to the header frame.

According to another aspect of the invention, a draper header is provided for harvesting agricultural crops. The draper header comprises a header frame, a draper belt, and a draper track assembly. The draper belt is rotatably supported by the header frame for transporting harvested agricultural crops. The draper belt includes a plurality of cleats extending laterally along an outer surface of the draper belt. The draper track assembly comprises a draper track, a support clamp and an intermediary support. The draper track has a track portion extending longitudinally from an inboard end to an outboard end and a mounting channel extending from a bottom of the track portion. A portion of the track portion extends between the draper belt and the header frame under the plurality of cleats on a return run of the draper belt. The support clamp is configured to be fixedly coupled to the mounting channel. The support clamp also is configured to be fixedly coupled to the header frame. The intermediary support has a bracket. The bracket and the mounting channel are configured to interlock with each other to prevent lateral movement between the draper track and the intermediary support while allowing longitudinal expansion of the draper track. The intermediary support is configured to be fixedly coupled to the header frame.

### BRIEF DESCRIPTION OF THE DRAWINGS

Advantages of the present disclosure will be readily appreciated as the same becomes better understood by reference to the following detailed description when considered in connection with the accompanying drawings, wherein:

FIG. 1 is a perspective view of a draper header according to one embodiment of the present invention;

FIG. 2 is a fragmentary perspective view of the draper header of FIG. 1;

FIG. 3 is a fragmentary bottom view of the draper header of FIG. 1;

FIG. 4 is a top view of the header frame and cutter bar assembly for the draper header of FIG. 1;

FIG. 5 is an enlarged fragmentary bottom perspective view of an inbound end of the header frame of FIG. 4 showing a draper track assembly;

FIG. 6 is an enlarged fragmentary bottom view of a front portion of the header frame of FIG. 4 showing the draper track assembly;

FIG. 7 is an enlarged fragmentary bottom view of an inboard portion of the header frame of FIG. 6 showing the draper track assembly;

FIG. 8 is a cross-sectional side view of the draper track;

FIG. 9 is a rear view of the inboard end of the header frame of FIG. 7 showing the draper track assembly;

FIG. 10 is a top perspective view of the header frame of FIG. 9;

FIG. 11 is an enlarged top perspective view of the header frame of FIG. 10;

FIG. 12 is a partially transparent perspective view of the draper track assembly of FIG. 11;

FIG. 13 is a perspective view of the inboard side of the draper track assembly according to a second embodiment of the present invention;

FIG. 14 is a partially transparent perspective view of the draper track assembly of FIG. 13;

FIG. 15 is a partially transparent perspective view of the draper track assembly according to a third embodiment of the present invention;

FIG. 16 is a partially transparent bottom view of a draper track assembly of FIG. 15;

FIG. 17 is a side view of the intermediate support; and

FIG. 18 is a cross-sectional view of the header frame of FIG. 7 taken along section line 18-18.

### DETAILED DESCRIPTION OF THE EMBODIMENTS

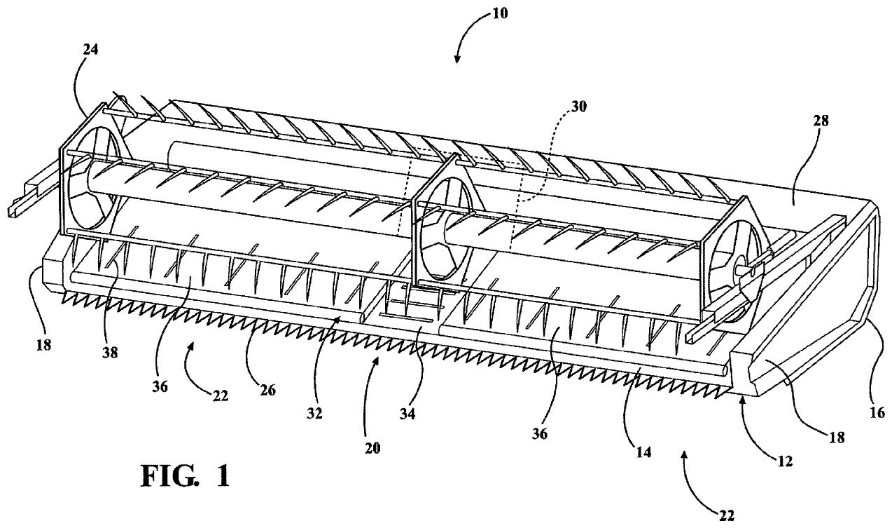

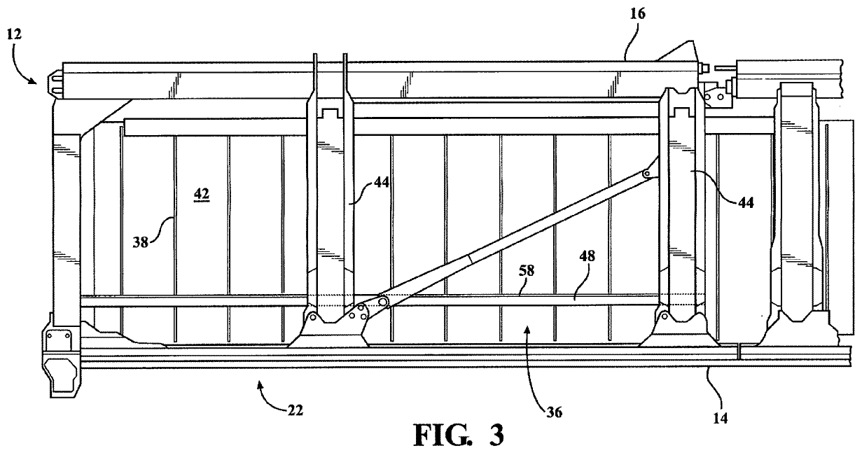

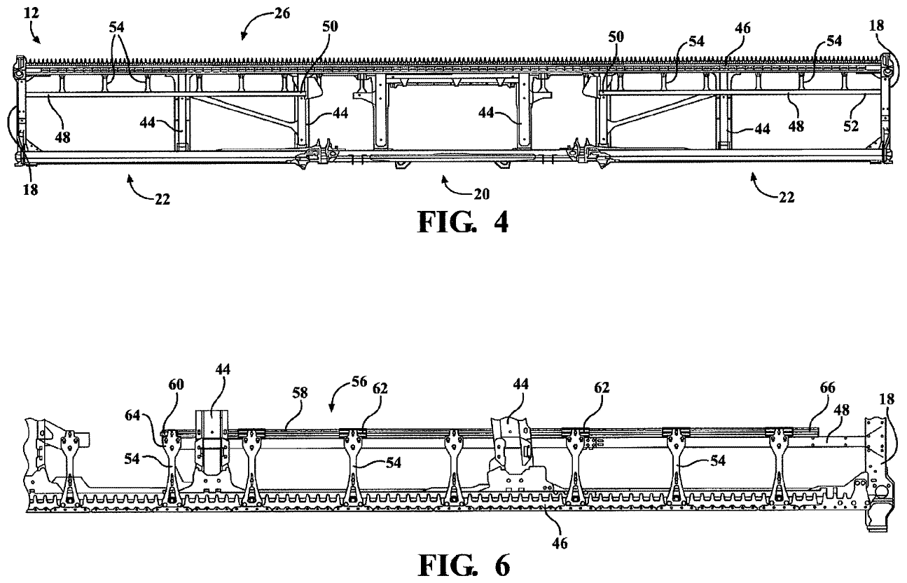

Referring to the Figures, wherein like numerals indicate like or corresponding parts throughout the several views, a draper header for harvesting agricultural crops is shown generally at 10. The header 10 includes a header frame 12 with a front portion 14 and a rear portion 16 extending longitudinally between opposite ends 18. Referring to FIGS. 1-4, the header frame 12 is divided into a middle frame section 20 pivotally coupled between a pair of side wing sections 22. The side wing sections 22 are pivotable upwardly and downwardly relative to the middle frame section 20 to contour to the field as the draper header 10 moves across the field harvesting crops. Alternatively, the middle frame section 20 may be rigidly coupled between the side wing sections 22. Referring to FIGS. 3-4, the header frame 12 also includes a plurality of header legs 44 extending between the front portion 14 and the rear portion 16 of each side wing section 22.

Referring to FIG. 1, crop pick-up reels 24 are positioned generally above the front portion 14 of the header frame 12 for engaging the crops to be harvested. A rear wall 28 extends substantially vertically along the rear portion 16 of the header frame 12 between the opposite ends 18 thereof. The rear wall 28 includes an opening 30 for transferring crops away from the header 10 for further processing by an agricultural machine such as a combine or for creation of windrows by a swather. However, it is to be appreciated that the crops may be transferred from the draper header 10 for any number of other suitable purposes without varying the scope of the invention.

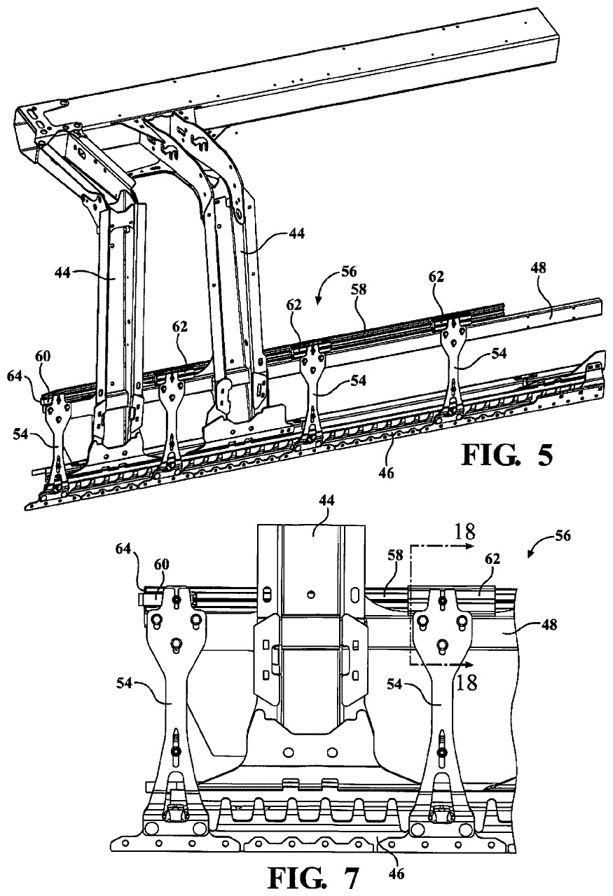

A cutter bar assembly 26 operatively extends across the front portion 14 of the header frame 12 between the opposite ends 18 for cutting the crops to be harvested. Referring to FIGS. 4 and 5, the cutter bar assembly 26 includes a guard bar 46 operatively coupled between the opposite ends 18 of the header frame 12 for supporting and mounting various components of the cutter bar assembly 26. The header frame 12 also includes an intermediate beam 48 on each side wing section 22. The intermediate beams 48 are positioned behind and extend substantially parallel to the guard bar 46. Each intermediate beam 48 extends between an inner end 50 and an opposite outer end 52. The outer ends 52 are coupled to the respective opposite ends 18 of the header frame 12. The guard bar 46 is coupled to the intermediate beams 48 by a plurality of flexible mounting components 54. Each mounting component 54 extends from a front end mounted to the bottom of the guard bar 46 to a rear end mounted to the bottom of the intermediate beam 48. The mounting components 54 are adapted to flex the cutter bar assembly 26 upwardly and downwardly relative to the header frame 12 for contouring to the field in coordination with the side wing sections 22 to optimally cut the crops.

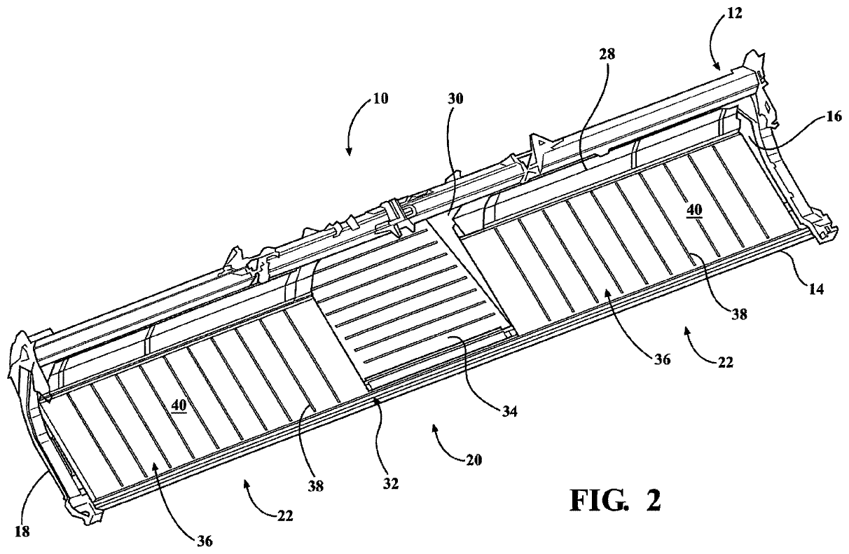

Referring to FIGS. 1-2, the header 10 further includes a draper belt assembly 32 supported by the header frame 12. The draper belt assembly 32 extends behind the cutter bar assembly 26 and includes a pair of side draper belts 36 on the side wing sections 22. When attached to a combine rather than a swather, the side draper belts 36 transport harvested agricultural crops to a feed draper belt 34 on the middle frame section 20, which then directs the harvested crops through the opening 30 in the rear wall 28.

Each side draper belt 36 is tensioned between a pair of spaced-apart rollers rotatably coupled between the front and rear portions 14, 16 of the header frame 12. Referring to FIGS. 1-3, each of the side draper belts 36 includes a plurality of cleats 38 extending laterally along an outer surface of the belt 36 in a direction perpendicular to the direction of belt travel. The cleats 38 aid in transporting the harvested crops. Each side draper belt 36 includes a top run 40 spaced above and parallel to an opposite return run 42. The return run 42 of each side draper belt 36 and their respective cleats 38 are supported by a draper track assembly 56.

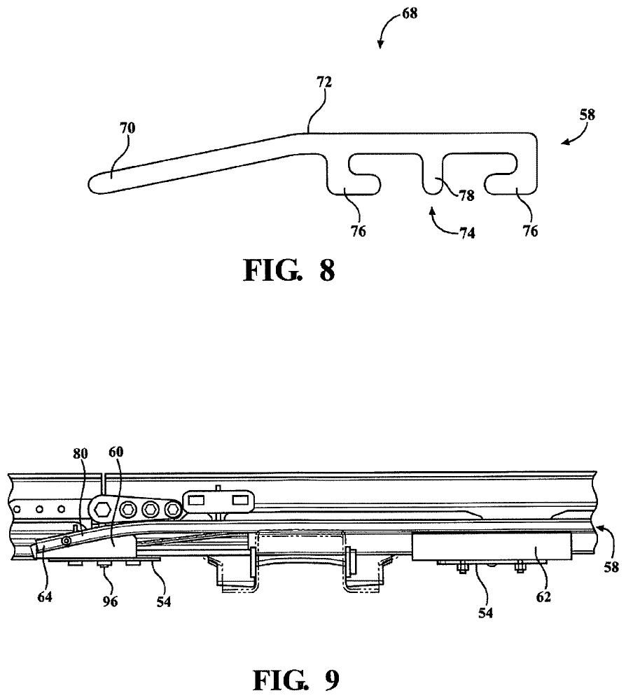

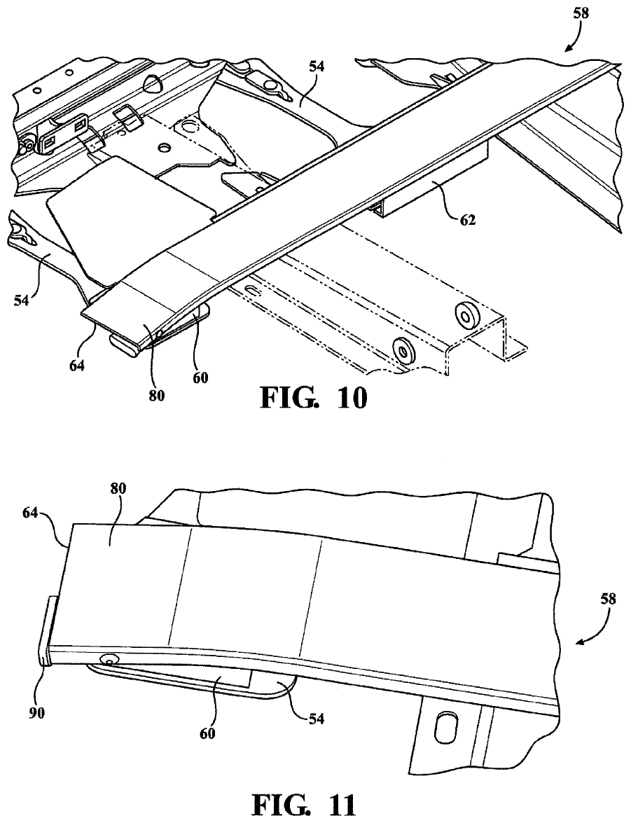

Referring to FIGS. 5-7, the draper track assembly 56 includes an elongated draper track 58, a support clamp 60, and a plurality of intermediate supports 62. The draper track 58 extends longitudinally between an inboard end 64 at the inner end 50 of the intermediate beam 48 and an opposite outboard end 66 adjacent the outer end 52 of the intermediate beam 48. Referring to FIG. 8, the draper track 58 includes a track portion 68 and a mounting channel 74 integrally molded to the bottom of the track portion 68. The mounting channel 74 is adjacent a rear edge of the track portion 68, but may be molded anywhere along the track portion 68 without altering the scope of the invention. The mounting channel 74 includes two c-shaped mounting arms 76 that extend inwardly toward the center of the mounting channel 74. The mounting channel 74 also includes a center rib 78 extending between the two mounting arms 76. A bend 72 extends along the track portion 68 to define a front track portion 70. Referring to FIGS. 9-11, the inboard end 64 of the draper track 58 bends downwardly to form a ramp 80. The draper track 58 may be integrally molded or extruded from plastic, such as Ultra High Molecular Weight Polyethylene (UHMW-PE).

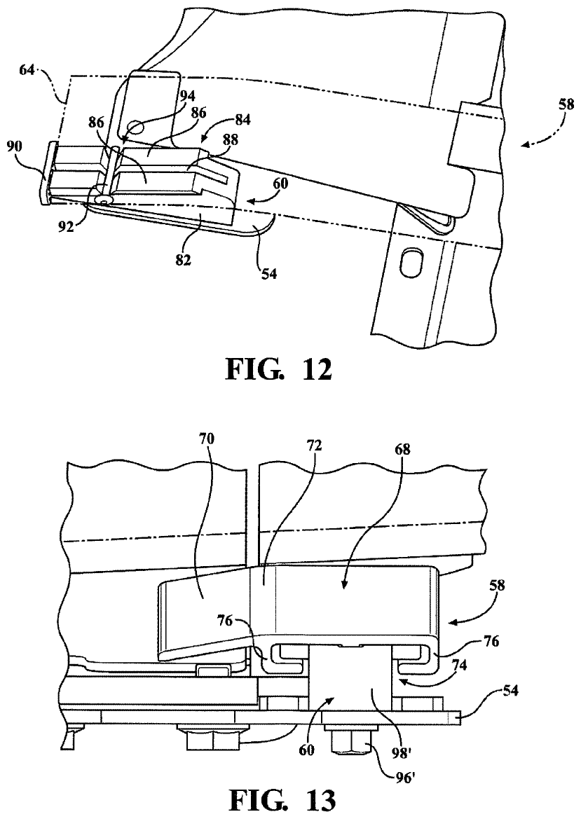

Referring to FIG. 12, the support clamp 60 includes a base 82 and a bracket 84 extending from the base 82. A slot 88 extends along the center of the bracket 84 to divide the bracket 84 into two sections 86. Each section 86 of the bracket 84 is configured to slide into one of the mounting arms 76 in the mounting channel 74 on either side of the center rib 78. The bracket 84 extends into the inboard end 64 of the draper track 58 and is sloped to create a lead-in for the ramp 80 on the draper track 58. The support clamp 60 also includes an end stop 90 at a distal end to ensure that the support clamp 60 remains at the inboard end 64 of the draper track 58. A fastener 92 is installed through the side of the draper track 58 and through a cutout 94 in the support clamp 60 to prevent the support clamp 60 from sliding out of the draper track 58. Mounting fasteners 96 (FIG. 9) secure the base 82 of the support clamp 60 to one of the flexible mounting components 54. The support clamp 60 is fully constrained to the mounting component 54 and the inboard end 64 of the draper track 58. The support clamp 60 may be made from plastic, sheet metal or any other suitable material.

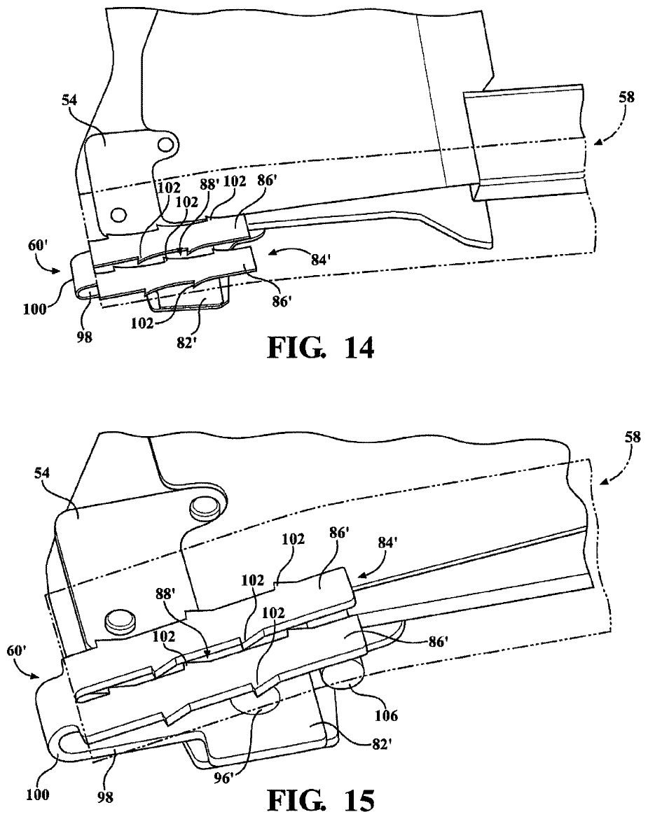

A second embodiment of the support clamp 60′ is shown in FIGS. 13-16, where like primed reference numerals represent similar elements as those described above. The support clamp 60′ in the second embodiment includes an arm 98 extending between the base 82′ and the bracket 84′. The arm 98 includes a bend 100 to ensure that the bracket 84′ is sloped to create a lead-in for the ramp 80 on the draper track 58. The slot 88′ aligns with the center rib 78 to ensure that the draper track 58 is installed in the correct location. Each section 86′ of the bracket 84′ includes teeth 102 protruding from both sides of the sections 86′. The teeth 102 are angled to allow the draper track 58 to easily slide over the bracket 84′ in one direction for installation. Once installed, the teeth 102 dig into the mounting arms 76 and the center rib 78 to provide positive retention and prevent the cleats 38 from pulling the draper track 58 off the support clamp 60′. The support clamp 60′ may be made from metal or any other suitable material. For example, the support clamp 60′ may be formed by bending a sheet metal fork.

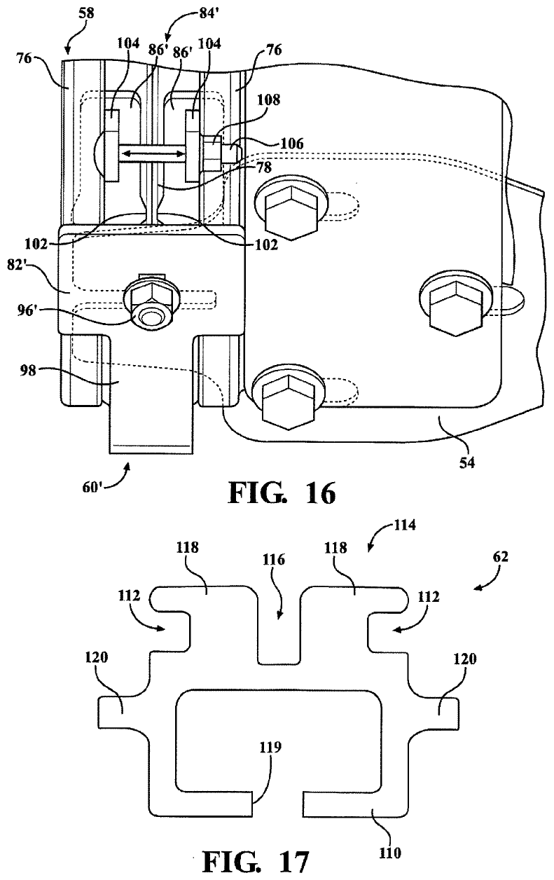

Referring to FIGS. 15-16, the support clamp 60′ may also include a tab 104 fixedly connected to the bottom of each section 86′ of the brackets 84′. The tabs 104 may be welded onto the sections 86′ or attached using any other means without departing from the scope of the invention. A bolt 106 and nut 108, or other suitable fasteners, may be used to clamp the two sections 86′ together on the center rib 78 of the draper track 58 to ensure that the draper track 58 cannot be pulled out of the support clamp 60′.

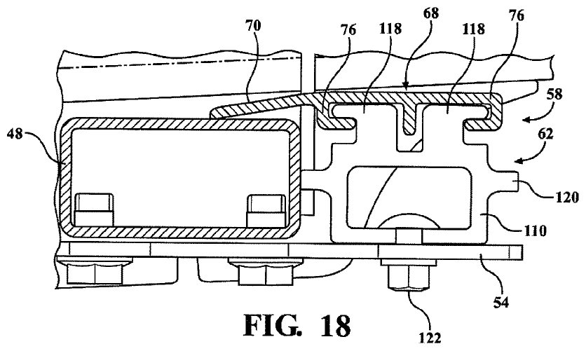

Referring to FIG. 17, each intermediate support 62 includes a rectangular base 110. Although generally rectangular in shape, the shape of the base 110 can vary without altering the scope of the invention. A pair of side slots 112 define a bracket 114 extending from the top of the base 110, and an upper slot 116 divides the bracket 114 into two sections 118. Each intermediate support 62 also includes a slot 119 at the bottom of the base 110 and a pair of spacing ribs 120 extending from either side of the rectangular base 110. Referring to FIG. 18, the spacing ribs 120 ensure that the intermediate support 62 is properly spaced from the intermediate beams 48.

As reflected in FIG. 18, the bracket 114 and the mounting channel 74 include opposing c-shaped configurations to interlock with each other. Each section 118 of the bracket 114 is configured to extend into one of the mounting arms 76 in the mounting channel 74, while the mounting arms 76 are configured to extend into the side slots 112, and the center rib 78 is configured to extend into the upper slot 116. It will be understood that the configuration interlocking the bracket 114 with the mounting channel 74 can vary without altering the scope of the invention. The interlocking of the bracket 114 with the mounting channel 74 prevents lateral and vertical movement between the draper track 58 and the intermediate support 62 while allowing longitudinal expansion of the draper track 58. Mounting fasteners 122 extend through the slot 119 in the base 110 of the intermediate support 62 to secure the base 110 to one of the flexible mounting components 54. The front track portion 70 of the draper track 58 extends over and is supported by the intermediate beams 48 throughout the length of the draper track 58.

Referring to FIGS. 5-7, the support clamp 60, 60′ connects the draper track 58 with the mounting component 54 at the inboard end 64 of the draper track 58 while the intermediate supports 62 connect the draper track 58 with the remaining mounting components 54 on the header frame 12. Although the inboard end 64 of the draper track 58 is fixedly mounted to the header frame 12, the draper track 58 may be fixedly mounted to the header frame 12 anywhere along the length of the draper track 58 without departing from the scope of the invention.

In operation, the cleats 38 on the return run 42 of the side draper belt 36 are initially guided onto the draper track 58 by the ramp 80. The front track portion 70 of the draper track 58 supports the cleats 38 on the entire return run 42 of the side draper belt 36 and prevents the cleats 38 from rubbing against the header frame 12. Because the draper track 58 material (e.g., UHMW-PE) has a lower coefficient of friction than the header frame 12, it reduces friction and wear on the side draper belts 36.

During use, as the draper track 58 heats up and is pulled away from the support clamp 60 at the inboard end 64 by the draper belts 36 running over the top of it, the draper track 58 is free to expand towards the outboard end 66, thereby eliminating potential track high points associated with the track movement being fully constrained in more than one location. The draper track 58 is designed with a consistent cross section along the entirety of its length, eliminating the requirement for secondary machining operations.

The invention has been described in an illustrative manner, and it is to be understood that the terminology which has been used is intended to be in the nature of words of description rather than of limitation. Directional references employed or shown in the description, figures or claims, such as top, bottom, upper, lower, upward, downward, lengthwise, widthwise, longitudinal, lateral, and the like, are relative terms employed for ease of description and are not intended to limit the scope of the invention in any respect. Many modifications and variations of the present invention are possible in light of the above teachings. It is, therefore, to be understood that within the scope of the appended claims, the invention may be practiced other than as specifically described.

What is claimed is:

1. A draper track assembly for use on a draper header for harvesting agricultural crops, wherein the draper header includes a header frame, the draper track assembly comprising:
a draper track having a track portion extending longitudinally from an inboard end to an outboard end and a mounting channel extending from a bottom of the track portion;
a support clamp configured to be fixedly coupled to the mounting channel wherein the support clamp is configured to be fixedly coupled to the header frame; and
an intermediary support having a bracket, wherein the bracket and the mounting channel are configured to interlock with each other to prevent lateral movement between the draper track and the intermediary support while allowing longitudinal expansion of the draper track, wherein the intermediary support is configured to be fixedly coupled to the header frame.

2. The draper track of claim 1, wherein:
the mounting channel includes a plurality of c-shaped mounting arms that extend inwardly toward a center of the mounting channel and a center rib extending between the mounting arms; and
the support clamp includes a base and a plurality of bracket sections extending from the base, wherein the bracket sections are configured to extend into the mounting arms along the center rib.

3. The draper track of claim 2, wherein the bracket sections include teeth configured to engage with the mounting channel to restrict movement in the longitudinal direction between the support clamp and the mounting channel.

4. The draper track of claim 2, further comprising a fastener configured to fixedly couple the support clamp to the draper track.

5. The draper track of claim 2, further comprising a fastener configured to clamp the plurality of bracket sections onto the center rib of the draper track.

6. The draper track of claim 2, wherein the support clamp includes an end stop to ensure that the support clamp remains at the inboard end of the draper track.

7. The draper track of claim 1, wherein the bracket and the mounting channel are configured to interlock with each other to prevent vertical movement between the draper track and the intermediary support while allowing longitudinal expansion of the draper track.

8. The draper track of claim 1, wherein the bracket and the mounting channel include opposing c-shaped configurations to interlock the bracket with the mounting channel.

9. The draper track of claim 1, further comprising a second intermediary support having a second bracket, wherein the second bracket and the mounting channel are configured to interlock with each other to prevent lateral movement between the draper track and the second intermediary support while allowing longitudinal expansion of the draper track, wherein the second intermediary support is configured to be coupled to the header frame.

10. The draper track of claim 1, further comprising a plurality of intermediary supports, wherein each of the plurality of intermediary supports includes a support bracket configured to interlock with the mounting channel to prevent lateral movement between the draper track and the intermediary supports while allowing longitudinal expansion of the draper track, wherein each of the plurality of intermediary supports is configured to be coupled to the header frame.

11. A draper header for harvesting agricultural crops, the draper header comprising:
a header frame;
a draper belt rotatably supported by the header frame for transporting harvested agricultural crops, wherein the draper belt includes a plurality of cleats extending laterally along an outer surface of the draper belt; and
a draper track assembly comprising:
a draper track having a track portion extending longitudinally from an inboard end to an outboard end and a mounting channel extending from a bottom of the track portion, wherein a portion of the track portion extends between the draper belt and the header frame under the plurality of cleats on a return run of the draper belt;
a support clamp configured to be fixedly coupled to the mounting channel wherein the support clamp is configured to be fixedly coupled to the header frame; and
an intermediary support having a bracket, wherein the bracket and the mounting channel are configured to interlock with each other to prevent lateral movement between the draper track and the intermediary support while allowing longitudinal expansion of the draper track, wherein the intermediary support is configured to be fixedly coupled to the header frame.

12. The draper header of claim 11, wherein:
the mounting channel includes a plurality of c-shaped mounting arms that extend inwardly toward a center of the mounting channel and a center rib extending between the mounting arms; and
the support clamp includes a base and a plurality of bracket sections extending from the base, wherein the bracket sections are configured to extend into the mounting arms along the center rib.

13. The draper header of claim 12, wherein the bracket sections include teeth configured to engage with the mounting channel to restrict movement in the longitudinal direction between the support clamp and the mounting channel.

14. The draper header of claim 12, wherein the draper track assembly further comprises a fastener configured to fixedly couple the support clamp to the draper track.

15. The draper header of claim 12, wherein the draper track assembly further comprises a fastener configured to clamp the plurality of bracket sections onto the center rib of the draper track.

16. The draper header of claim 12, wherein the support clamp includes an end stop to ensure that the support clamp remains at the inboard end of the draper track.

17. The draper header of claim 11, wherein the bracket and the mounting channel are configured to interlock with each other to prevent vertical movement between the draper track and the intermediary support while allowing longitudinal expansion of the draper track.

18. The draper header of claim 11, wherein the bracket and the mounting channel include opposing c-shaped configurations to interlock the bracket with the mounting channel.

19. The draper header of claim 11, wherein the draper track assembly further comprises a second intermediary support having a second bracket, wherein the second bracket and the mounting channel are configured to interlock with each other to prevent lateral movement between the draper track and the second intermediary support while allowing longitudinal expansion of the draper track, wherein the second intermediary support is configured to be coupled to the header frame.

20. The draper header of claim 11, wherein the draper track assembly further comprises a plurality of intermediary supports, wherein each of the plurality of intermediary supports includes a support bracket configured to interlock with the mounting channel to prevent lateral movement between the draper track and the intermediary supports while allowing longitudinal expansion of the draper track, wherein each of the plurality of intermediary supports is configured to be coupled to the header frame.
